(19) United States
(12) Patent Application Publication
(10) Pub. No.: US 2016/0255643 A1
(43) Pub. Date: Sep. 1, 2016

(54) METHODS AND APPARATUS FOR RECEIVING LTE-U NETWORK INFORMATION

(71) Applicant: QUALCOMM Incorporated, San Diego, CA (US)

(72) Inventors: Rahul Malik, San Diego, CA (US); Hemanth Sampath, San Diego, CA (US)

(21) Appl. No.: 15/051,491

(22) Filed: Feb. 23, 2016

Related U.S. Application Data
(60) Provisional application No. 62/126,433, filed on Feb. 27, 2015.
(60) Provisional application No. 62/126,434, filed on Feb. 27, 2015.
(60) Provisional application No. 62/126,427, filed on Feb. 27, 2015.
(60) Provisional application No. 62/126,436, filed on Feb. 27, 2015.
(60) Provisional application No. 62/126,431, filed on Feb. 27, 2015.

(51) Int. Cl. H04W 72/12

(52) U.S. Cl. CPC H04W 72/1215; H04W 84/12

(57) ABSTRACT

Certain aspects of the present disclosure relate to a methods and apparatus for wireless communication. In one aspect, a method of decoding additional information about long-term evolution unlicensed (LTE-U) communications for enhancing wireless communication performance can include receiving, from a LTE-U device, a first wireless local area network (WLAN) packet reserving a communication medium over a time period. The first WLAN communication includes information about a LTE-U communication. The method further includes decoding, at a wireless device, information about the LTE-U communication.

### PRIORITY CLAIM

This application claims the benefit of U.S. Provisional Application No. 62/126,433, filed Feb. 27, 2015; U.S. Provisional Application No. 62/126,434, filed Feb. 27, 2015; U.S. Provisional Application No. 62/126,427, filed Feb. 27, 2015; U.S. Provisional Application No. 62/126,436, filed Feb. 27, 2015; and U.S. Provisional Application No. 62/126,431, filed Feb. 27, 2015; each of which is hereby incorporated herein by reference in its entirety.

### FIELD

Certain aspects of the present disclosure generally relate to wireless communications, and more particularly, to controlling and managing use of common wireless communication resources for devices utilizing different communication standards.

### BACKGROUND

For increasing volume and complexity of information communicated wirelessly between multiple devices in a wireless communication system, the requirement for managing a level of acceptable interference continues to increase. Such devices may operate in close proximity to one another while operating over a common frequency spectrum in accordance with different communication standards. Two of such systems standards are commonly known as long-term evolution (LTE) and wireless local area network (WLAN). Use of a common frequency by different devices inherently creates the possibility of experiencing interference while such devices are accessing the communication resources. Certain governmental regulatory agency makes spectrum available for wireless services, including licensed and unlicensed spectrums. Generally, wireless communications over the licensed frequencies are limited to one or more particular use and location. The licensed frequency spectrum has generally been provided for Cellular Market Areas (CMAs). The frequency spectrum designated as “unlicensed” or “licensed-exempt,” allows the users to freely operate wireless devices while complying with certain technical requirements, including transmission power limits. Users of the unlicensed frequency spectrum do not have exclusive use of the spectrum and are subject to interference by other users.

Generally, the particulars of the system protocol for operating in the licensed and unlicensed frequency spectrums may be different. The LTE standard allows LTE devices to operate in both licensed and unlicensed frequency spectrums. The WLAN devices may also be operating in the same unlicensed frequency spectrum. The LTE devices operating in the unlicensed frequency spectrum are generally known as LTE-U devices. LTE-U and WLAN devices may utilize a common frequency spectrum at essentially the same time or overlapping time periods. To reduce and possibly avoid a level of interference experienced by LTE-U and WLAN devices operating in a common unlicensed frequency spectrum, there is a need for controlling and managing use of the wireless communication resources.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

One aspect provides a method of decoding additional information about long-term evolution unlicensed (LTE-U) communications for enhancing wireless communication performance. The method includes receiving, from a LTE-U device, a first wireless local area network (WLAN) packet reserving a communication medium over a time period. The first WLAN communication includes information about a LTE-U communication. The method further includes decoding, at a wireless device, information about the LTE-U communication.

In various embodiments, the method can further include receiving, from the LTE-U device, a second WLAN communication prior to transmission of the first WLAN communication, the second WLAN communication reserving the communication medium over the time period. In various embodiments, reception of the second WLAN communication can occur no later than a short interframe space (SIFS) time after a previous communication on the communication medium. In various embodiments, at least one of the first WLAN communication and the second WLAN communication can include a clear-to-send to self (C2S) packet.

In various embodiments, the first WLAN communication can include an indication of a presence of the information about the LTE-U communication in the first WLAN communication, the method further can include decoding the information about the LTE-U communication. In various embodiments, the second WLAN communication can include an indication of a presence of the information about the LTE-U communication in the first WLAN communication, the method further can include decoding the information about the LTE-U communication. In various embodiments, the second WLAN communication can include an indication of a presence of the first WLAN communication, the method further can include decoding the information about the LTE-U communication.

In various embodiments, the method can further include determining a presence of the information about the LTE-U communication based on a value in an information element of the first WLAN communication, the method further can include decoding the information about the LTE-U communication. In various embodiments, the method can further include determining a presence of the information about the LTE-U communication based on a value in an information element of the second WLAN communication, the method further can include decoding the information about the LTE-U communication.

In various embodiments, the method can further include determining one or more of a channel, duty-cycle, duration, and a periodicity of a LTE-U network. The method can further include determining one or more of a channel, duty-cycle, duration, and a periodicity of a WLAN network.

In various embodiments, the method can further include nulling interference from the LTE-U device. The method can further include receiving another communication from another device during the time period.

In various embodiments, the method can further include determining a channel-estimate from the LTE-U device based on the information about the LTE-U communication included in the first WLAN communication. In various embodiments, the information about the LTE-U communication can include a value in one or more training signals located in the first WLAN communication.

In various embodiments, the method can further include determining a utilization of the communication medium by the LTE-U device based on the information about the LTE-U communication in the first WLAN communication. The method can further include communicating with other devices based on the utilization.

In various embodiments, the method can further include determining a time period for a communication from the LTE-U device based on the information in the first WLAN communication. The method can further include determining a channel for the communication based on the information in the first WLAN communication. The method can further include scheduling a transmission or reception of another WLAN communication on a different channel during the time period.

In various embodiments, the information can include one or more of: an identifier of a LTE-U network or LTE-U network operator; a position of the first WLAN communication with respect to the LTE-U communication; an identifier of one or more channels occupied by the LTE-U network; a periodicity and/or duty-cycle/duration of the LTE-U communication.

Another aspect provides an apparatus for wireless communication. The apparatus includes a receiver configured to receive from a LTE-U device, a first wireless local area network (WLAN) packet reserving a communication medium over a time period, the first WLAN communication including information about a LTE-U communication. The apparatus further includes a processor configured to decode information about the LTE-U communication.

In various embodiments, the receiver can be further configured to receive a second WLAN communication prior to transmission of the first WLAN communication, the second WLAN communication reserving the communication medium over the time period. In various embodiments, the receiver can be further configured to receive the second WLAN communication no later than a short interframe space (SIFS) time after a previous communication on the communication medium. In various embodiments, at least one of the first WLAN communication and the second WLAN communication can include a clear-to-send to self (C2S) packet.

In various embodiments, the first WLAN communication can include an indication of a presence of the information about the LTE-U communication in the first WLAN communication, the method further can include decoding the information about the LTE-U communication. In various embodiments, the second WLAN communication can include an indication of a presence of the information about the LTE-U communication in the first WLAN communication, the method further can include decoding the information about the LTE-U communication. In various embodiments, the second WLAN communication can include an indication of a presence of the first WLAN communication, the method further can include decoding the information about the LTE-U communication.

In various embodiments, the processor can be further configured to determine a presence of the information about the LTE-U communication based on a value in an ethertype field of the first WLAN communication. The processor can be further configured to decode the information about the LTE-U communication.

In various embodiments, the processor can be further configured to determine a presence of the information about the LTE-U communication based on a value in an ethertype field of the second WLAN communication. The processor can be further configured to decode the information about the LTE-U communication.

In various embodiments, the processor can be further configured to determine one or more of a channel, duty-cycle, duration, and a periodicity of a LTE-U network based on the information about the LTE-U communication in the first WLAN communication. The processor can be further configured to determine one or more of a channel, duty-cycle, duration, and a periodicity of a WLAN network based on the first WLAN communication.

In various embodiments, the receiver can be further configured to null interference from the LTE-U device. The processor can be further configured to receive another WLAN communication from another device during the time period.

In various embodiments, the processor can be further configured to determine a channel-estimate from the LTE-U device based on the information about the LTE-U communication included in the first WLAN communication.

Another aspect provides another apparatus for wireless communication. The apparatus includes means for receiving a first wireless local area network (WLAN) packet that reserves a communication medium over a time period, the first WLAN communication including information about a LTE-U communication. The apparatus further includes means for decoding information about the LTE-U communication.

Another aspect provides a non-transitory computer readable medium. The medium includes code that, when executed, causes an apparatus to receive, from a LTE-U device, a first wireless local area network (WLAN) packet reserving a communication medium over a time period, the first WLAN communication including information about a LTE-U communication. The medium further includes code that, when executed, causes the apparatus to decode information about the LTE-U communication.

### BRIEF DESCRIPTION OF THE DRAWINGS

FIG. 1 illustrates an example of a wireless communication system in which various aspects of the present disclosure may be employed.

FIG. 2 illustrates various components that may be utilized in a wireless device that may be employed within the wireless communication system of FIG. 1.

FIG. 3 illustrates a time sequence diagram of exemplary communications of LTE and WLAN devices.

FIG. 4 illustrates an exemplary WLAN communication format in accordance with embodiments described herein.

FIG. 5 illustrates another time sequence diagram of exemplary communications of LTE and WLAN devices.

FIG. 6 is a flow chart for wireless communication in accordance with an exemplary implementation.

FIG. 7 is a flow chart for wireless communication in accordance with another exemplary implementation.

FIG. 8 is a flow chart for wireless communication in accordance with another exemplary implementation.

### DETAILED DESCRIPTION

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently or combined with any other aspect of the disclosure. In addition, the scope is intended to cover such an apparatus or method which is practiced using other structure and functionality as set forth herein. It should be understood that any aspect disclosed herein may be embodied by one or more elements of a claim.

Although particular aspects are described herein, variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description. The detailed description and drawings are merely illustrative of the disclosure rather than limiting, the scope of the disclosure being defined by the appended claims and equivalents thereof.

The word “exemplary” is used herein to mean “serving as an example, instance, or illustration.” Any implementation described herein as “exemplary” is not necessarily to be construed as preferred or advantageous over other implementations. The following description is presented to enable any person skilled in the art to make and use the embodiments described herein. Details are set forth in the following description for purpose of explanation. In other instances, well-known structures and processes are not elaborated in order not to obscure the description of the disclosed embodiments with unnecessary details. Thus, the present application is not intended to be limited by the implementations shown, but is to be accorded with the broad scope consistent with the principles and features disclosed herein.

A WLAN device as described herein may use the protocols described in any of the 802.11 family of standards, such as 802.11a, 802.11ah, 802.11ac, 802.11n, 802.11g, 802.11b, and others. The WLAN device may be an access point (“AP”), or a station (“STA”). In general, an AP serves as a hub or a base station for the STAs in the communication network. An STA may be a laptop computer, a personal digital assistant (PDA), a mobile phone, etc. In general, an STA wirelessly connects to an AP via an IEEE 802.11 protocol communication link to have, for example, a wireless connectivity to the Internet, other devices and other networks. An STA may also operate as an AP.

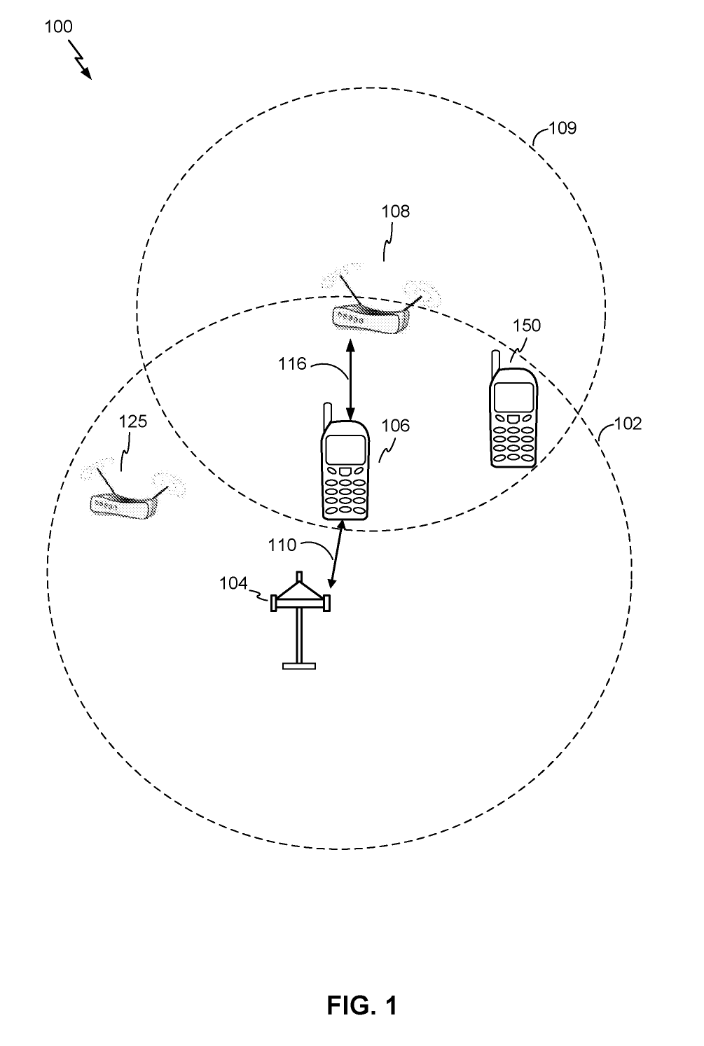

FIG. 1 illustrates an example of a wireless communication system 100 that may be incorporating various aspects of the present disclosure. Wireless communication system 100 may include an STA 106, a base station (BS) 104 and an AP 108. The BS 104 may provide wireless communication coverage in a coverage area 102. The AP 108 may provide wireless communication coverage in a basic service area (BSA) 109. The wireless communications in coverage area 102 and BSA 109 may include communications in an unlicensed frequency spectrum. A wireless communication connectivity service in accordance with LTE-U protocols may be provided by BS 104. Providing such a service includes at least transmission of LTE-U communications (e.g., data packets). In accordance with an embodiment, WLAN communications may also be transmitted by BS 104, for example, for data communications or to protect the LTE-U communications. Therefore, in accordance with an embodiment, a wireless communication link 110 between BS 104 and STA 106 may include transmission and reception of data packets in accordance with LTE-U and WLAN protocols. The AP 108 may communicate with STA 106 over a wireless communication link 116 in accordance with WLAN protocols in the unlicensed frequency spectrum. As such, wireless communication links 116 and 110 may occur over a common unlicensed frequency spectrum at the same time or overlapping time periods.

Embodiments described herein are particularly related to coexisting operations of LTE-U and WLAN devices using common communication resources (e.g., frequency spectrum and transmission time). Generally, wireless communication system 100 includes many different devices aspects of which may operate over a common unlicensed frequency spectrum. Some of these devices may be operating in accordance with WLAN protocols (WLAN devices) and while others in accordance with the LTE-U protocol (LTE-U devices). The LTE-U and WLAN wireless communication links with such devices may occur at essentially the same time or overlapping time periods. Sharing communication resources such as the frequency spectrum and the available transmission times typically create coexistence problems for devices operating in accordance with two different protocols (e.g., LTE-U and WLAN). Generally, the WLAN devices may not detect the presence of an LTE-U signal, and thus being unaware of the presence of LTE-U communication while transmitting WLAN signals. Such coexisting operations would cause interference for the LTE-U communications, and may limit access for the LTE-U device to the same frequency spectrum during desired time periods. The LTE-U communications may also be causing interference for the WLAN communications. As a result, the WLAN and the LTE-U devices may experience degradation of communication data throughput as well as collisions of transmitted signals. Various aspects of the disclosure improve the efficiency of using the unlicensed frequency spectrum in wireless communication system 100 where the possibility exists for different transmissions to occur in accordance with WLAN and LTE-U protocols. In accordance with an embodiment, BS 104, while providing wireless connectivity services in accordance with LTE-U protocols, transmits WLAN communications.

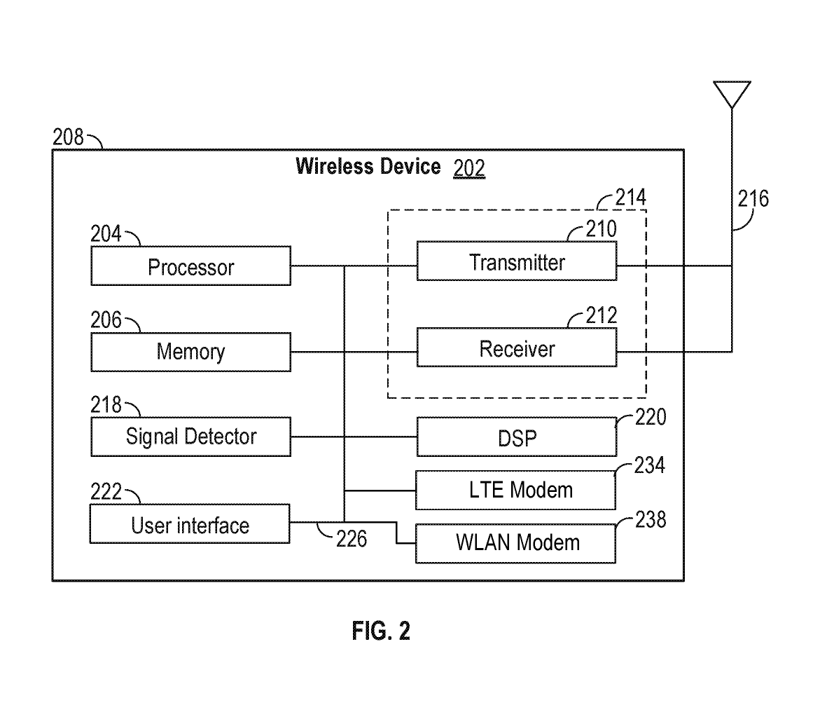

For example, illustrated wireless communication system 100 may further include an AP 125 and user equipment (UE) 150 operating within coverage area 102. Both AP 125 and UE 150 may receive communications from BS 104. The AP 125 and UE 150 may adjust their operations in response to receiving such communications. In some embodiments, AP 125 may include hardware and/or software (e.g., LTE modem 234 and WLAN modem 238 shown in FIG. 2) such that it is able to decode reception of certain LTE-U network information. For example, AP 125 may decode, embedded within a WLAN communication, information regarding reception of an LTE-U communication or LTE-U network information.

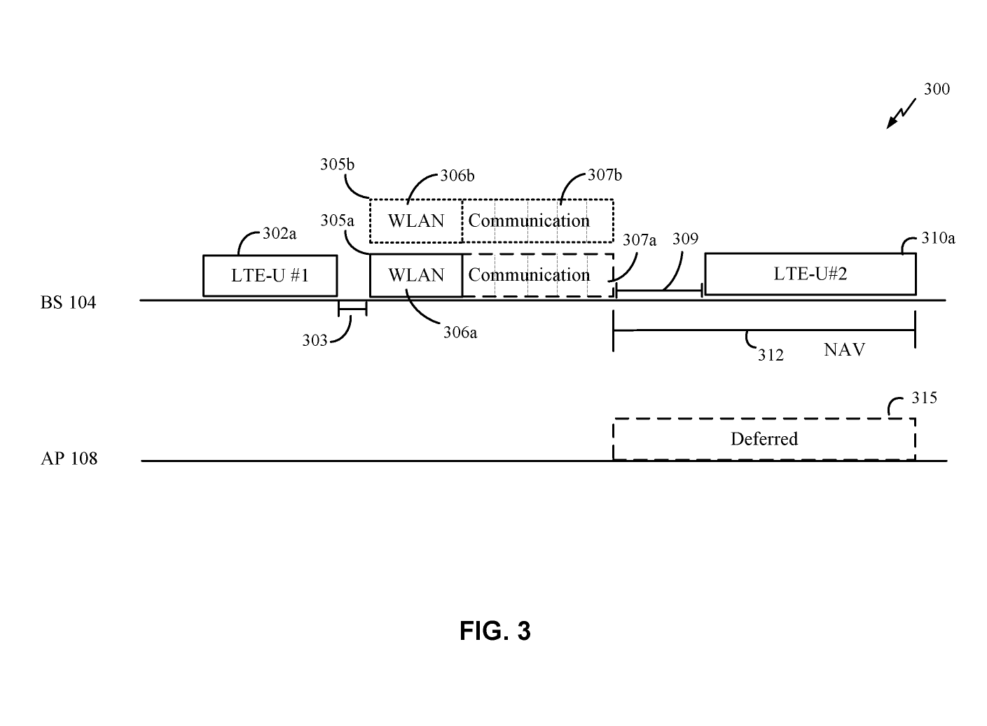

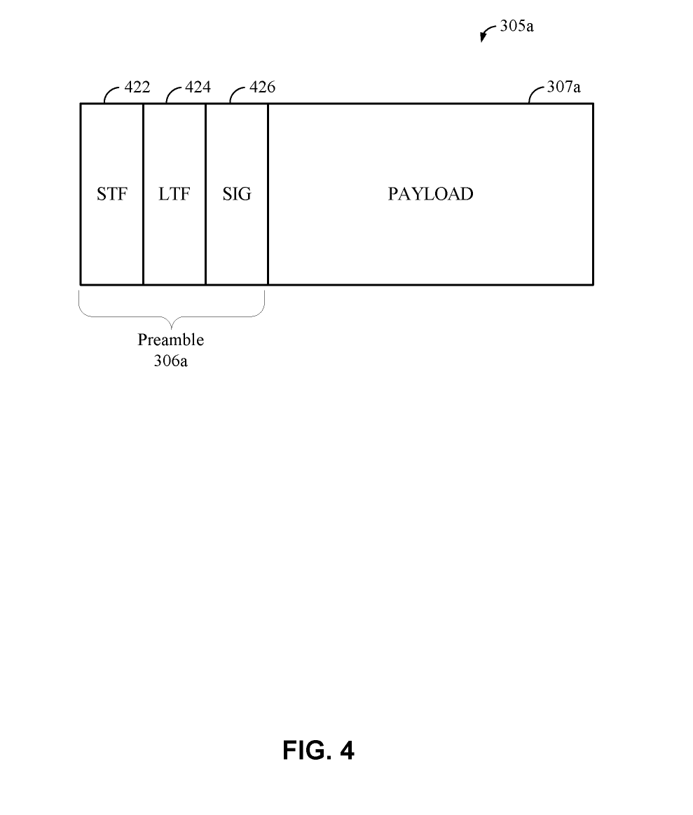

In accordance with various aspects of the disclosure and as described in more detail below, in some embodiments BS 104 may schedule a LTE-U communication to UE 150 or STA 106. In accordance with an embodiment, BS 104 may transmit a WLAN communication embedded with LTE-U network information for the LTE-U communication to reduce interference from a transmission of WLAN devices and/or reserve a communication medium for the scheduled LTE-U communication. As discussed in greater detail herein, for example with respect to FIGS. 2-4, BS 104 may operate with LTE modem 234 (FIG. 2) and WLAN modem 238 (FIG. 2) to generate WLAN communication 305a (FIG. 4) embedded with information about LTE-U communication 310a (FIG. 3). WLAN devices (e.g., AP 108 and AP 125) receiving the WLAN communication may use the information about the LTE-U communication to avoid interference, for example by setting a network allocation vector (NAV) based on the WLAN communication (e.g., based on a packet duration indication in a signal field of the WLAN communication) or by communicating on a different channel than the LTE-U communication so as to reduce interference for the LTE-U communication.

FIG. 2 illustrates various components of a wireless device 202 for operation in wireless communication system 100. Wireless device 202 is suitable for performing the operations as may be required by BS 104, AP 108 or STA 106. The wireless device 202 may be configured and used differently for BS 104, AP 108 or STA 106 depending on the various operations that may be required in wireless communication system 100.

The wireless device 202 may include a processor 204 which may control operation of wireless device 202. Processor 204 may also be referred to as a central processing unit (CPU) or hardware processor. Processor 204 typically performs logical and arithmetic operations based on program instructions stored within a memory 206 which may include both read-only memory (ROM) and random access memory (RAM). A portion of memory 206 may also include non-volatile random access memory (NVRAM). The instructions in memory 206 may be executable to implement various aspects described herein. Processor 204 may include or be a component of a processing system implemented with one or more processors and may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

Processor 204 and memory 206 may include non-transitory machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein. The processor 204 may further include a data packet generator to generate data packets for controlling operation and data communication.

Wireless device 202 may include a transmitter 210 and a receiver 212 to allow wireless transmission and reception of data. Transmitter 210 and receiver 212 may be combined into a transceiver 214. An antenna 216 may be electrically coupled to transceiver 214. Although not shown, wireless device 202 may include multiple transmitters, multiple receivers, and/or multiple antennas. In an embodiment, although not shown, an antenna may be dedicated for each of the LTE-U and WLAN communications. Moreover, a receiver and a transmitter may be dedicated to for each of the LTE-U and WLAN communications. The operations associated with LTE-U and WLAN communications may also be performed collectively by the same receiver and transmitter. Wireless device 202 may be enclosed by a housing unit 208.

Wireless device 202 may also include an LTE modem 234 for LTE-U communications. Wireless device 202 may also include a WLAN modem 238 for WLAN communication. LTE modem 234 and WLAN modem 238 may contain processing capabilities for operations associated with processing at both the physical (PHY) layer and the medium access control (MAC) layer of the corresponding LTE-U and WLAN protocols. Although LTE modem 234 and WLAN modem 238 are shown separately, one of ordinary skill in the art may appreciate that the functions performed by these two components may be performed by a common component of wireless device 202, or their functions can be linked via hardware and/or software. Moreover, the functions associated with LTE modem 234 and WLAN modem 238 may also be performed by other components such as processor 204 and a digital signal processor (DSP) 220.

Wireless device 202 may transmit and receive both LTE-U and WLAN communications over antenna 216, transmitter 210, and receiver 212, each of which may be operationally connected to LTE modem 234 and WLAN modem 238. As disclosed herein, wireless device 202 may not require all the functionalities and components as shown and described when wireless device 202 is being used and implemented in AP 108, BS 104 or STA 106. In accordance with the disclosure, the basic functionality of WLAN modem 238 may be limited to processing transmission of WLAN data packets. For example, wireless communication link 110 between BS 104 and STA 106 may include transmission and reception of LTE-U communication and transmission of WLAN communications. Therefore, in BS 104, the basic functionality of WLAN modem 238 may be limited to processing transmission of WLAN communications.

Wireless device 202 may also include a signal detector 218 to detect and quantify the level of received signals. Signal detector 218 may detect such signals in a form of detecting total energy, energy per subcarrier per symbol, power spectral density and others. Wireless device 202 may also include DSP 220 for use in processing signals. DSP 220 may operationally be connected and share resources with processor 204 and other components.

Wireless device 202 may further include a user interface 222 in some aspects. User interface 222 may include any element such as a keypad, a microphone, a speaker, and/or a display for conveying information to a user of wireless device 202 and/or receives input from the user. Various components of wireless device 202 may be coupled together by a bus system 226 which may include for example a data bus, a power bus, a control signal bus, and a status signal bus.

Although a number of separate components are illustrated in FIG. 2, one of ordinary skill in the relevant art would appreciate that one or more of these components may be implemented not only with respect to the functionality described above, but also to perform the functionality associated with respect to other components. For example, processor 204 may be used to perform not only the functionality described with respect to processor 204, but also the functionality associated with signal detector 218 and/or DSP 220. Each of the components illustrated in FIG. 2 may be implemented using a plurality of separate elements.

In an exemplary embodiment, BS 104 may be configured for communicating in accordance with the operation of LTE-U protocol while also configured to transmit in accordance with the WLAN protocol. As such, when wireless device 202 is configured to operate as BS 104, WLAN modem 238 can be configured to form and facilitate transmission of such WLAN communications from BS 104. Further, in accordance with an embodiment, when transmitted by BS 104, the WLAN communication is embedded with information about LTE-U communication. The transmission of the WLAN communication may be incorporated with LTE-U communications for improving or ensuring availability of frequency spectrum and timing resources for the LTE-U communications to take place having reduced receive interference from other possible WLAN communications in the unlicensed frequency spectrum. BS 104 while incorporating transmission of a WLAN communication with LTE-U communications to STA 106 or any other device reduces the possibility of experiencing interference at a receiver of the LTE-U communication from transmission of WLAN communication by other WLAN devices in wireless communication system 100. While referring to a configuration of wireless device 202 in BS 104, processor 204 or DSP 220 may operate with LTE modem 234 and WLAN modem 238 for generating and transmitting the WLAN communication and the LTE-U communication in accordance with an exemplary embodiment. In accordance with an embodiment, the WLAN communication may also be embedded with information about LTE-U communication.

When in possible close proximity to the BS 104, AP 108 may also receive the transmissions made by BS 104. As such, AP 108 is also receiving the WLAN communication having been incorporated in the LTE-U communication and transmitted by BS 104. AP 108 while receiving such a transmission from BS 104 may defer transmission of its own WLAN communication or may communicate by transmitting on a different channel than the frequency channel used for the LTE-U communication. As such, the LTE-U communication transmitted by BS 104 may continue and be received at STA 106 at possibly a reduced level of interference or no interference from possible WLAN transmissions by AP 108. Other WLAN devices in wireless communication system 100 receiving the WLAN communication having been incorporated in the LTE-U communication and transmitted by BS 104 may also defer transmission of their own WLAN communication or may communicate by transmitting on a different channel than the frequency channel used for the LTE-U communication. The WLAN communication having been incorporated in the LTE-U communication, as such, protects transmission and reception of the LTE-U communication at a reduced level of interference or no interference from other possible WLAN transmissions in wireless communication system 100. One example of the WLAN communication protecting the LTE-U communication is shown and described below with respect to FIG. 3.

FIG. 3 illustrates an exemplary time sequence diagram 300 in wireless communication system 100 including LTE-U and WLAN devices. The top portion of FIG. 3 shows transmissions from BS 104 and the bottom portion shows an operation of AP 108 in response to receiving the transmissions made by BS 104. Other WLAN devices in wireless communication system 100 receiving the transmissions of BS 104 may operate in a similar manner as shown and described for AP 108. As is generally shown and described, BS 104 transmits the WLAN communication having been incorporated in the LTE-U communication for reserving the medium (i.e., frequency and time) for the LTE-U communication causing AP 108 and other WLAN devices to defer their WLAN transmissions during certain time periods.

The exemplary time sequence diagram 300 is described and shown by BS 104 transmitting a first LTE-U communication 302a. The first LTE-U communication 302a may be an LTE-U communication at the start of a channel access process, or a continuation of previous LTE-U communications. After a time period 303, BS 104 transmits WLAN communication 305a. WLAN devices receiving WLAN communication 305a may defer transmission for a time period based on a time duration indication in WLAN communication 305a. Accordingly, WLAN devices (e.g., AP 108) receiving WLAN communication 305a may defer or set its network allocation vector (NAV) for at least a time period 312 which begins at the end of WLAN communication 305a transmission and lasts until the end of a second LTE-U communication 310a. Thus, AP 108 can refrain from transmitting WLAN communications 315 during transmission of LTE-U communication 310a, avoiding overlapping “on” periods.

One of ordinary skill in the art may appreciate that the 802.11 standards have provided a full description for how NAV is expected to operate within a communication system. Generally, NAV is an indicator for a station on how long it must defer from accessing the medium (i.e., transmission frequency and time). NAV may be implemented in the device as a counter, which counts down to zero at a uniform rate. When the counter is zero, its indication is that the medium is idle. As long as NAV counter has a nonzero value, the indication is that the medium is being used by another device (i.e., busy). In accordance with an embodiment, a possible value for NAV may be included in WLAN communication 305a. The WLAN stations receiving WLAN communication 305a may set their NAV counter value accordingly. WLAN devices deferring transmissions during time period 312 allow second LTE-U communication 310a to be received at a reduced or without interference from possible transmissions from other WLAN devices that would have otherwise could have been taking place during time period 312, at least. In various embodiments, WLAN devices may defer transmission upon receiving WLAN communication 305a. WLAN devices that are in an idle state may take no action upon receiving WLAN communication 305a.

WLAN communication 305a may be divided into two parts, namely a WLAN preamble 306a portion and a WLAN payload portion 307a. In some aspects, WLAN devices receiving WLAN communication 305a may decide to decode only WLAN preamble 306a portion and not WLAN payload portion 307a. Certain WLAN devices (such as WLAN devices commonly known as WLAN Legacy devices) may only be concerned with decoding WLAN preamble 306a portion and ignore WLAN payload portion 307a. In accordance with an aspect of the disclosure, LTE-U network information for LTE-U communication 310a may be included in payload portion 307a. The WLAN devices may decode WLAN preamble 306a portion and set their NAV accordingly based on the decoded WLAN preamble 306a portion. In some aspects, WLAN devices receiving WLAN communication 305a may be able to, and decide to, decode both WLAN preamble 306a portion and WLAN payload portion 307a which may contain LTE-U network information for LTE-U communication 310a. The WLAN devices that are able and decide to decode WLAN payload portion 307a may use the decoded LTE-U network information for the LTE-U communication 310a included in WLAN payload portion 307a to set their NAV. The NAV information included in WLAN preamble 306a portion may be ignored by such devices.

Referring to FIG. 3, BS 104 may begin transmitting LTE-U communication 310a after a time period 309. In some embodiments, BS 104 may utilize one or more of LTE modem 234, processor 204, DSP 220, antenna 216, transmitter 210, and transceiver 214 shown in FIG. 2, to generate and transmit LTE-U communication 310a. Since BS 104 may have been transmitting LTE-U communication 302a before transmission of WLAN communication 305a, LTE-U communication 310a may be considered as a second LTE-U communication in a series of LTE-U communications made by BS 104.

In some embodiments, a length of transmission time of WLAN communication 305a including time periods 303 and 309 could be as long as one LTE-U OFDM slot duration. In some embodiments, a length of transmission time of WLAN communication 305a including time periods 303 and 309 could be as long as one LTE-U OFDM sub-frame duration. One of ordinary skill in the relevant art may appreciate that one LTE-U OFDM slot duration and one LTE-U OFDM sub-frame duration are defined in relevant LTE-U standards.

Generally, WLAN devices that operate in compliance with an earlier version of the 802.11 standards, such as 802.11 a/b/g, are categorized as legacy WLAN devices. Such legacy devices may operate freely with other WLAN devices operating in compliance with the later versions of the WLAN standard. The devices complying with the later versions of the WLAN standard should operate in such a manner that would not cause the legacy devices to be in a disadvantaged condition for accessing the system communication resources. A protection protocol may be followed to reduce or avoid problems for legacy devices. For example, if legacy devices are within range, protection mechanisms, such as use of mixed-mode preamble and operating in non-HT (non-high-throughput) duplicate mode, are designed to protect legacy networks and devices from potential disruption caused by operating in accordance with the new protocols. Following the established protection mechanisms, the WLAN devices can use the new protocols without disrupting the legacy networks or devices. One ordinary skill in the art may appreciate that details of such protections are provided in relevant 802.11 standard.

In some embodiments, BS 104 may transmit WLAN communication 305a in a non-high throughput (non-HT) duplicate mode. In this mode, BS 104 may transmit duplicates of WLAN communication 305a on each channel of a frequency bandwidth. This duplication may allow for WLAN devices to receive and decode WLAN communication 305a on any channel, and set their NAV accordingly. As shown in FIG. 3, WLAN communication 305b includes a duplicate of WLAN communication 305a transmitted by BS 104 on a separate channel. WLAN communication 305b may be divided into two parts, namely a WLAN preamble portion 306b and a WLAN payload portion 307b. In some embodiments, BS 104 may transmit WLAN communication 305a on one 20 MHz channel and WLAN communication 305b on a second 20 MHz channel of a 40 MHz frequency bandwidth. In some aspects, BS 104 may transmit more or fewer duplicate packets depending on the size of the operating frequency bandwidth and/or the size of the operating channel bandwidth. For example, BS 104 may transmit duplicate packets across 20, 40, 80, or 160 MHz channels.

BS 104 may transmit a ‘filler waveform’ during time period 303. In some embodiments, the ‘filler waveform’ may comprise energy in the channel or additional WLAN or LTE-U OFDM symbols or parts thereof, transmitted prior to the start of the transmission of WLAN communication 305a or transmission of LTE-U communication 310a. In some embodiments, the filler waveform transmitted during time period 303 may have an energy or power level that is lower than the energy or power level of WLAN communication 305a or LTE-U communication 310a.

In some embodiments, BS 104 may utilize one or more of LTE modem 234, WLAN modem 238, processor 204, DSP 220, antenna 216, transmitter 210, and transceiver 214 of FIG. 2, to generate and transmit WLAN communication 305a. In some aspects, BS 104 may transmit WLAN communication 305a using an 802.11-based modulation and coding scheme. In some embodiments, time period 303 may include a short interframe space (SIFS) time or may include a longer or shorter time duration. SIFS is an amount of time, typically in micro seconds, required for a wireless interface to process a received frame and be able to respond with a response frame. A SIFS time consists of the delay in receiver RF, Physical Layer Convergence Procedure (PLCP) delay and the MAC processing delay, which depends on the physical layer used and may be different for different versions of 802.11 standards.

Time period 303 may include an idle duration for sensing the channel for ‘listen before talk’ channel access procedure or contention procedures for the channel. The ‘listen before talk’ channel access and contention procedures may include procedures consistent with carrier sense multiple access (CSMA) or 802.11 protocols. While using the terminology “node” for referring to devices operating in wireless communication system 100, in some embodiments, time period 303 may be chosen to allow for the transmission of WLAN communication 305a to be slot-synchronized with transmission of other WLAN nodes (e.g., WLAN nodes within coverage area 102). Time period 303 may be chosen such that it allows for transmission of WLAN communication 305a to be slot synchronous with operation of other LTE-U nodes (e.g., LTE-U nodes within coverage area 102).

In some embodiments, time period 309 may include a SIFS duration. In some embodiments, time period 309 may be reduced to a time period lasting no more than a predetermined amount of time such as 18 or 20 microseconds, and in some embodiments, time period 309 may be reduced to a negligible amount such that it has effectively been eliminated. In some embodiments, BS 104 may determine time period 309 based on the time needed to synchronize itself with the LTE-U frame timing in coverage area 102 or wireless communication system 100.

In some embodiments, BS 104 may transmit a ‘filler waveform’ during time period 309 that may comprise of energy on the channel or additional WLAN or LTE-U OFDM symbols or parts thereof, prior to the start of the LTE-U communication 310a. In some aspects, the filler waveform may allow BS 104 to maintain a hold or access on the channel. For example, the filler waveform may be transmitted at an energy or power level sufficient to satisfy channel access rules in some regulatory regions. In some embodiments, the filler waveform transmitted during time period 309 may have an energy level that is lower than the energy level of WLAN communication 305a or LTE-U communication 310a.

In some aspects, a WLAN device (e.g., AP 108) receiving WLAN communication 305a may decode payload portion 307a and communicate the decoded LTE-U network information (for example, associated devices, communication timing, channel usage, etc.) via a management frame or an information element (IE) in a management frame to other WLAN devices. Accordingly, a WLAN device may provide information, such as avoiding transmission during LTE-U communications, to other WLAN devices. As such, the level of interference is reduced from possible transmissions from such WLAN devices. In some aspects, AP 108 may use a public action frame to transmit the LTE-U network information to other WLAN devices. In some aspects, AP 108 may transmit the LTE-U network information via transmission of a data frame. In some aspects, such a transmission by AP 108 may be in response to a request frame from a nearby WLAN device. In some aspects, this request frame may be a probe-request frame.

In some embodiments, WLAN devices (e.g., AP 108) receiving the WLAN communication 305a may defer or set the network allocation vector (NAV) for a time period 312 which begins at the end of the WLAN communication 305a transmission and lasts until the end of second LTE-U communication 310a. In some embodiments, these WLAN devices may not be equipped with hardware or software that allows them to decode or detect LTE-U communications or information about the LTE-U communications. However, as discussed herein, WLAN communication 305a may contain information about the LTE-U communication 310a in a manner that is transparent to WLAN devices not embodying the methods of the invention, while not impacting the these WLAN devices' ability to receive and decode set the NAV. In some embodiments, WLAN devices (e.g., AP 108) receiving WLAN communication 305a may be equipped with hardware or software that allows them to decode or detect certain LTE-U communications or information about the LTE-U communications. For example, this group of WLAN devices with additional hardware or software may be able to detect the channels in use by the LTE-U devices and communications, their duty cycle, timing and periodicity, the operator/network name/identifier, list of neighboring base-stations, etc. (e.g., from WLAN communication 305a and WLAN communication 305b).

In some embodiments, in addition to detecting channels being used by LTE-U communications, WLAN devices may additionally detect the identity of the LTE-U network and additional information pertaining to the LTE-U network operation. WLAN devices may use the identity of the LTE-U network or the additional information regarding the LTE-U network to better schedule its own communications around the LTE-U network communications, to aid in network discovery or network timing, to determine the periodicity or duty cycle of LTE-U communications to aid in carrier sense adaptive transmission (CSAT) timing, to facilitate fast LTE-U network discovery and association using the WLAN modem, e.g., a phone implementing both LTE-U and WLAN technologies leveraging its Wi-Fi modem to facilitate quick discovery and association with an LTE-U base-station, or for other beneficial uses.

In some aspects, WLAN devices (e.g., AP 108) receiving WLAN communication 305a may aggregate LTE-U network information that it observes and transmit it over a WLAN via a management frame or an information element (IE) in a management frame. In some aspects, AP 108 may transmit LTE-U network information and transmit it via a public action frame. In some aspects, AP 108 may transmit the LTE-U network information via a data frame. In some aspects, the transmission by AP 108 may be in response to a request frame from a nearby WLAN device. In some aspects, this request frame may be a probe-request frame.

FIG. 4 is a diagram of an exemplary WLAN communication 305a format. WLAN communication 305a may include WLAN preamble 306a portion and payload portion 307a. In some embodiments, the format of WLAN communication 305a may include format of any existing WLAN communication defined in various 802.11 standards. For example, WLAN communication 305a can include any of packets CTS, CTS-to-self, any other 802.11 packet that sets the NAV appropriately. In some aspects, WLAN communication 305a may include a clear-to-send to self (C2S) packet. In some aspects WLAN communication 305a may be transmitted using a non-HT duplicate transmission mode.

WLAN preamble 306a portion may be generated such that it is decodable by all WLAN devices within a receiving range of WLAN communication 305a. WLAN preamble 306a may include a short training field (STF) 422, a long training field (LTF) 424, and a signal (SIG) field 426. In one embodiment, SIG field 426 may include a duration indication that could be signaling other WLAN devices to set their NAV and defer transmission during the indicated duration. In some embodiments, WLAN preamble 306a portion may contain more or fewer fields.

Payload portion 307a may include one or more OFDM symbols and may include LTE-U network information for the LTE-U communication as well as WLAN information. In some embodiments, payload portion 307a may contain more or fewer fields. In some embodiments, WLAN communication 305a may contain more or fewer portions and may include a frame format consistent with one or more of 802.11a, 802.11ah, 802.11ac, 802.11n, 802.11g, 802.11b, or other 802.11 based standards.

In some embodiments, WLAN communication 305a may include an indication that WLAN communication 305a contains information relating to LTE-U communication 310a (i.e., the second LTE-U communication). The indication can alert certain WLAN devices that are capable of understanding the indication (“LTE-U aware WLAN devices”) that additional information regarding an LTE-U communication is forthcoming. In some embodiments, the information relating to LTE-U communication 310a can be included without prior indication. In various embodiments, the indication, or the information relating to LTE-U communication 310a, can be encoded in a manner that does not disrupt communication for non-LTE-U aware WLAN devices, while allowing LTE-U aware WLAN devices to receive the additional information. Accordingly, upon receiving the indication, a LTE-U aware WLAN device can obtain the information relating to LTE-U communication 310a.

In various embodiments, the indication may be located in various portions of WLAN communication 305a such that a device decoding WLAN communication 305a may determine that WLAN communication 305a contains information about LTE-U communication 310a. In some embodiments, the indication may be included in preamble 306a portion of WLAN communication 305a. For example, the indication may be encoded in signal (SIG) field 426 of preamble 306a. In other embodiments, the indication may be encoded in a medium access control (MAC) header portion of WLAN communication 305a. For example, the indication may include a locally managed MAC address or, when WLAN communication 305a includes a C2S, may include a MAC address with a multicast address. In some embodiments, the indication may include a value in an information element or a frame type field of WLAN communication 305a. In some embodiments, the indication may include the transmission of a frame with a specific vendor specific information element (IE). In some embodiments, the indication may include a separate management frame transmitted to indicate presence of the LTE-U network information for the LTE-U communication in WLAN communication 305a. In some aspects, the management frame may include a public action frame. In some embodiments, the indication may include a separate control frame transmitted to indicate the presence of the LTE-U network information for the LTE-U communication in WLAN communication 305a.

Additionally, the information about LTE-U communication 310a may be located in various portions of WLAN communication 305a. In some aspects, the information may be located in preamble 306a of WLAN communication 305a. In some aspects, the information may be located in payload portion 307a of WLAN communication 305a. In some aspects, the information may be encoded in a payload portion 307a of WLAN communication 305a. For example, the information may be encoded in a service field of WLAN communication 305a.

In some embodiments, the information about LTE-U communication 310a may include an identifier of a LTE-U network or LTE-U network operator. In some aspects, the information includes one or more of a position of WLAN communication 305a with respect to LTE-U communication 310a; an identifier of one or more channels occupied by the LTE-U network, for example for transmission of LTE-U communication 310a; and a periodicity and/or duty-cycle/duration of LTE-U communication 310a. Accordingly, WLAN devices receiving the information about the LTE-U communication 310a by way of receiving WLAN communication 305a may be deferring transmission during LTE-U communication 310a or by changing their communication to another channel frequency.

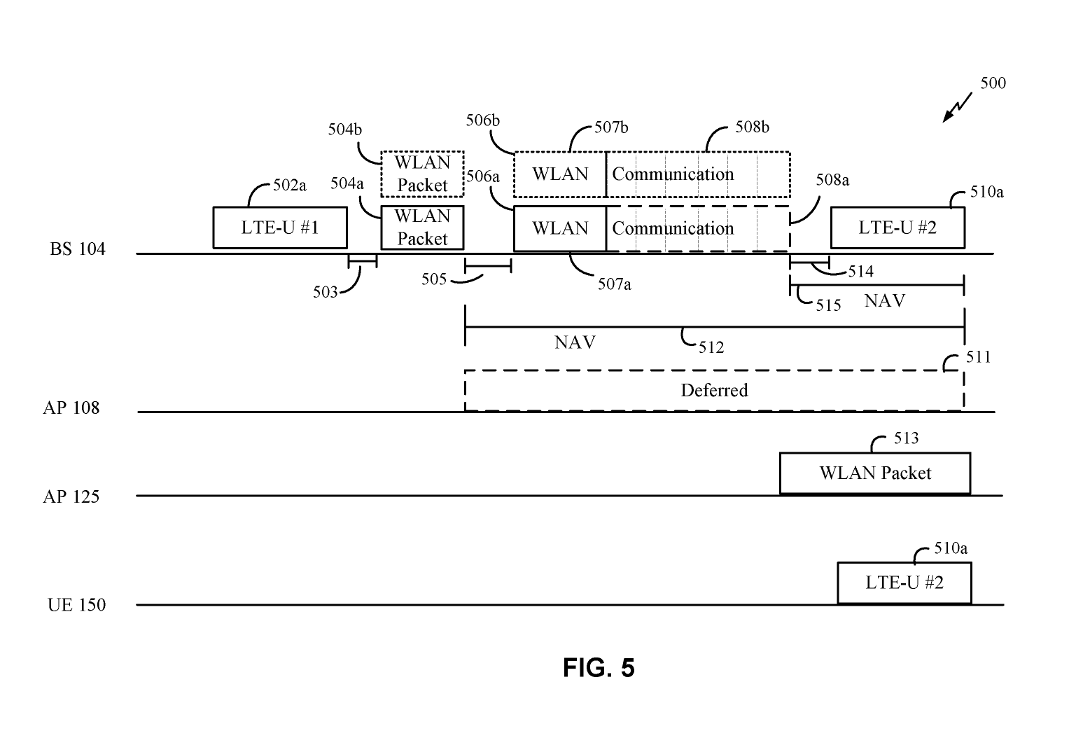

Referring back to FIG. 3, the illustrated embodiment shows a single WLAN communication 305a (or two simultaneously transmitted communications 305a and 305b) that both sets NAV time period 312 and includes LTE-U information. In other embodiments, one or more additional WLAN communications can be subsequently transmitted to set the NAV, in addition to a WLAN communication that includes LTE-U information. For example, a double-packet configuration can be chosen where some receiving devices do not honor the NAV set by WLAN communications including the LTE-U information. One embodiment of such a double-packet configuration is shown in FIG. 5.

FIG. 5 illustrates a time sequence diagram 500 of exemplary communications in wireless communication system 100 including LTE and WLAN devices. Wireless communication system 100 may include other devices such as a user equipment (UE) 150 operating in accordance with the LTE-U standard and may be a UE that is in communication with BS 104. Wireless communication system 100 may include many devices such UE 150 at a time, and many of which may be in communication with BS 104. Wireless communication system 100 may also include other WLAN devices, including WLAN STAs and APs. One such AP is shown as AP 125. The top portion of FIG. 5 shows transmissions from BS 104. The operation of AP 108 in response to BS 104 transmissions is also shown. The operation of AP 125 in response to a transmission from BS 104 is also shown. The operation of UE 150 in response to a transmission from BS 104 is also shown at the bottom of FIG. 5.

BS 104 transmits a first LTE-U communication 502a. The first LTE-U communication 502a may include a continuation of previous communications. In some embodiments, such as at the start of channel access process, first LTE-U communication 502a may not be present. After a time period 503, BS 104 transmits a first WLAN communication 504a. In some embodiments, BS 104 may utilize one or more of LTE modem 234, WLAN modem 238, processor 204, DSP 220, antenna 216, transmitter 210, and transceiver 214 of FIG. 2, to generate and transmit first WLAN communication 504a. In some embodiments, time period 503 may include a short interframe space (SIFS) time or may include a longer or shorter time duration. Time period 503 may include an idle duration for sensing the channel for ‘listen before talk’ channel access procedure or contention procedures for the channel. The length of time period 503 may be chosen such that the length of time allows for the transmission of WLAN communication 504a to be slot-synchronized with other WLAN nodes (e.g., WLAN nodes within coverage area 102). The length of time period 503 may be chosen such that it allows for transmission of WLAN communication 504a to be slot synchronous with other LTE-U nodes (e.g., LTE-U nodes within coverage area 102). In some embodiments, BS 104 may transmit a filler waveform during time period 503.

WLAN communication 504a may include a WLAN preamble portion and a payload portion (not shown). In some embodiments, the format of WLAN communication 504a may include format of any existing WLAN communication defined in various 802.11 standards. For example, WLAN communication 305a can include any of packets CTS, CTS-to-self, any other 802.11 packet that sets the NAV appropriately. In some aspects, WLAN communication 305a may include a clear-to-send to self (C2S) packet. In some aspects WLAN communication 305a may be transmitted using a non-HT duplicate transmission mode. In some embodiments, WLAN communication 504a may include a format and effect similar to that of WLAN communication 305a shown and described in relation with FIGS. 3-4. In some embodiments, WLAN communication 504a may be a WLAN communication and include a frame format consistent with one or more of 802.11a, 802.11ah, 802.11ac, 802.11n, 802.11g, 802.11b, or other 802.11 based standards, and may be containing more or fewer portions. WLAN devices (e.g., AP 108) receiving WLAN communication 504a may defer transmission or set their network allocation vector (NAV) for a time period 512 which begins at the end of WLAN communication 504a transmission and lasts until the end of LTE-U communication 510a which may be the second LTE-U communication after the first LTE-U communication (i.e., 502a) WLAN devices may defer transmission upon receiving WLAN communication 504a. WLAN devices that are idle or have no information to send or receive may need not to take any particular action upon receiving WLAN communication 504a.

BS 104 may transmit WLAN communication 506a after a time period 505. Time period 505 is between the first WLAN communication (i.e., WLAN communication 504a) and the second WLAN communication (i.e., WLAN communication 506a). In some embodiments, BS 104 may utilize one or more of LTE modem 234, WLAN modem 238, processor 204, DSP 220, antenna 216, transmitter 210, and transceiver 214 of FIG. 2, to generate and transmit WLAN communication 506a. In some embodiments, time period 505 may include a SIFS time or may include a shorter time durations. In some aspects, time period 505 may include a time period of no more than 18-20 microseconds. In some aspects, BS 104 may transmit a ‘filler waveform’ during time period 505. In some embodiments, the filler waveform may be transmitted at a power level that is lower than that used for transmission of WLAN communication 504a, WLAN communication 506a or LTE-U communications 510a. Transmission of WLAN communication 506a may also allow BS 104 to send LTE-U communication 510a and be received at its destination at a reduced interference level or without interference from possible transmission of WLAN devices.

WLAN communication 506a may include a WLAN preamble portion 507a and a payload portion 508a. In some embodiments, the format of WLAN communication 506a may include format of any existing WLAN communication defined in various 802.11 standards. For example, WLAN communication 305a can include any of packets CTS, CTS-to-self, any other 802.11 packet that sets the NAV appropriately. In some aspects, WLAN communication 506a may include a clear-to-send to self (C2S) packet. In some aspects WLAN communication 506a may be transmitted using a non-HT duplicate transmission mode. WLAN preamble portion 507a may be generated such that it is decodable by all WLAN devices (i.e., including the legacy devices) within a receiving range of WLAN communication 506a. Payload portion 508a may include one or more OFDM symbols and may include LTE-U network information for the LTE-U communication as well as WLAN information. In some embodiments, WLAN communication 506a may include a format similar to that of WLAN communication 305a shown and described in relation with FIGS. 3-4. In some embodiments, WLAN communication 506a packet may contain more or fewer portions and may include a frame format consistent with one or more of 802.11a, 802.11ah, 802.11ac, 802.11n, 802.11g, 802.11b, or other 802.11 based standards. WLAN communication 506a allows reserving a communication medium (i.e., frequency and time) for BS 104 to transmit LTE-U communication 510a (i.e., a second LTE-U communication) WLAN devices, such as, AP 108, receiving WLAN communication 506a may defer their transmission or by setting their NAV to defer their transmission for a time period 515 which begins at the end of WLAN communication 506a transmission and lasts until the end of LTE-U communication 510a.

BS 104 may transmit LTE-U communication 510a after a time period 514 shown to be after the transmission of WLAN communication 506a, and thus allowing reception of LTE-U communication 510a at reduced interference level from possible transmission by the WLAN devices in wireless communication system 100. In some embodiments, BS 104 may utilize one or more of LTE modem 234, processor 204, DSP 220, antenna 216, transmitter 210, and transceiver 214 of FIG. 2, to generate and transmit LTE-U communication 510a. In some embodiments, time period 514 may include a SIFS duration. In some embodiments, time period 514 may be reduced to a time period lasting no more than 18-20 microseconds and in some embodiments, time period 514 may be reduced to a negligible amount or practically reduced to zero. In some embodiments, BS 104 could determine time period 514 based on the time required to synchronize itself with the LTE-U frame timing.

In some embodiments, BS 104 may transmit a ‘filler waveform’ during time period 514 that may comprise of energy on the channel or additional WLAN or LTE-U OFDM symbols or parts thereof, prior to the start of the LTE-U communication 510a. In some embodiments, BS 104 may transmit WLAN communication 504a (i.e., the first WLAN communication) and WLAN communication 506a (i.e., the second WLAN communication) such that the total duration to transmit both WLAN communication 504a and WLAN communication 506a (including time periods 503, 505 and 514) fits within one LTE-U OFDM symbol duration. Accordingly, BS 104 may adjust time periods 503 and 505 and the lengths of WLAN communication 504a and/or WLAN communication 506a to fit such a transmission timing within a desired OFDM symbol duration. In some embodiments, BS 104 may transmit WLAN communication 504a and WLAN communication 506a such that the total duration to transmit both WLAN communication 504a and WLAN communication 506a (including time periods 503, 505 and 514) fits within one LTE-U OFDM slot duration. In some embodiments, BS 104 may transmit WLAN communication 504a and WLAN communication 506a such that the total duration to transmit both WLAN communication 504a and WLAN communication 506a fits within one LTE-U OFDM sub-frame duration.

In some embodiments, BS 104 may transmit WLAN communication 504a and/or WLAN communication 506a in a non-high throughput (non-HT) duplicate mode. Similar to WLAN communications 305a and 305b described with respect to FIG. 3, BS 104 may transmit duplicate WLAN communications 504b and/or 506b over two different 20 MHz channels of a 40 MHz frequency bandwidth. Like WLAN communication 506a, WLAN communication 506b may include a WLAN preamble portion 507b and a payload portion 508b. In some aspects, BS 104 may transmit more or fewer duplicate packets depending on the size of the frequency bandwidth and/or the size of the channels.

Similar to WLAN communication 305a described in relation with FIG. 3, in some embodiments, WLAN communication 504a and/or second WLAN communication 506a may include an indication that WLAN communication 504a and/or WLAN communication 506a contains information relating to LTE-U communication 510a and more broadly the LTE-U network described herein. The indication can alert certain WLAN devices that are capable of understanding the indication (“LTE-U aware WLAN devices”) that additional information regarding an LTE-U communication is forthcoming. In some embodiments, the information relating to LTE-U communication 510a can be included without prior indication. In various embodiments, the indication, or the information relating to LTE-U communication 504a or 506a, can be encoded in a manner that does not disrupt communication for non-LTE-U aware WLAN devices, while allowing LTE-U aware WLAN devices to receive the additional information. Accordingly, upon receiving the indication, a LTE-U aware WLAN device can obtain the information relating to LTE-U communication 502a or 510a.

In various embodiments, the indication may be located in various portions of WLAN communication 504a and/or WLAN communication 506a such that a device decoding WLAN communication 504a and/or WLAN communication 506a may determine that WLAN communication 504a and/or WLAN communication 506a contains information about LTE-U communication 510a. In some embodiments, the indication may be included in a preamble portion of WLAN communication 504a and/or WLAN communication 506a. For example, the indication may be encoded in a signal (SIG) field of preamble portion 507a of WLAN communication 506a. In other embodiments, the indication may be encoded in a medium access control (MAC) header portion of WLAN communication 504a and/or WLAN communication 506a. For example, the indication may include a locally managed MAC address or, when WLAN communication 504a and/or WLAN communication 506a includes a C2S packet, the indication may include a MAC address with a multicast address. In some embodiments, the indication may include a value in an information element or a frame type field of WLAN communication 504a and/or WLAN communication 506a. In some embodiments the indication may include the transmission of a frame with a specific vendor specific information element (IE). In some embodiments, the indication may include a separate management frame transmitted to indicate the presence of the LTE-U network information for the LTE-U communication. In some aspects, the management frame may include a public action frame. In some embodiments, the indication may include a separate control frame transmitted to indicate the presence of the LTE-U network information for the LTE-U communication in WLAN communication 504a and/or WLAN communication 506a.

Additionally, the information about LTE-U communication 510a and more broadly about the LTE-U network may be located in various portions of WLAN communication 504a and/or WLAN communication 506a. In some aspects, the information may be located in the preamble portion of WLAN communication 504a and/or WLAN communication 506a. In some aspects, the information may be located in a payload portion of WLAN communication 504a and/or WLAN communication 506a. In some aspects, the information may be located in payload portion 508a of WLAN communication 506a. For example, the information may be encoded in a service field of WLAN communication 506a.

In some embodiments, the information may include an identifier of a LTE-U network or LTE-U operator. In some aspects, the information includes one or more of a position of WLAN communication 504a and/or WLAN communication 506a with respect to LTE-U communication 510a; an identifier of one or more channels occupied by the LTE-U network (e.g., second LTE-U communication 510a); and a periodicity and/or duty-cycle/duration of LTE-U communication 510a.

As discussed above with respect to FIG. 3, and as shown in FIG. 5, in some aspects, WLAN devices (e.g., AP 108) receiving WLAN communication 504a may defer accessing the communication medium (i.e., frequency and time) and/or set their NAV for a time period 511 which begins at the end of WLAN communication 504a transmission and lasts at least until the end of LTE-U communication 510a or to transmission of the next such WLAN communication(s); and coincides with time period 512 set by WLAN communication 504a. Thus, AP 108 can refrain from transmitting WLAN communications in time period 511 during transmission of WLAN communication 506, avoiding overlapping “on” periods.

AP 125 may also be operating in wireless communication system 100. AP 125 may receive WLAN communication 504a and/or WLAN communication 506a; however, it may determine or decide not to set the NAV based on the received information about LTE-U communication 510a. AP 125 may ignore the information provided in one or both of WLAN communication 504a and WLAN communication 506a. In some embodiments, AP 125 may receive and process WLAN communications 504a and/or 506b utilizing one or more of LTE modem 234, WLAN modem 238, processor 204, DSP 220, antenna 216, receiver 212, and transceiver 214 of FIG. 2, to receive and process WLAN communications 504a and 506a.

Additionally, AP 125 may determine the channel information for LTE-U communication 510a from the received WLAN communications (i.e., 504a, or 506a or both) and select a different channel to transmit WLAN communication 513. As shown in FIG. 5, AP 125 selects a different channel than the channel used for LTE-U communication 510a. As such, AP 125 communicates with other WLAN devices during at least a portion of the same time period as the second LTE-U communication 510a.

In various embodiments, UE 150 and/or any other device can receive LTE-U communication 510a from BS 104. Accordingly, WLAN communication 513 can be received by a WLAN device at the same time as the second LTE-U communication 510a is received by UE 150. Such contemporaneous transmission and reception of WLAN communication 513 and LTE-U communication 510a can be made possible by the channel avoidance mechanism set forth above.

In some embodiments, AP 125 may be further equipped and/or configured to detect and decode additional information about the LTE-U communications. As discussed above, WLAN devices such as AP 125 may use this additional information to better schedule its own communications around the LTE-U network communications, to aid in network discovery or network timing, to determine the periodicity or duty cycle of LTE-U communications to aid in carrier sense adaptive transmission (CSAT) timing, or to facilitate fast LTE-U network discovery and association using the WLAN modem—e.g., such as a phone implementing both LTE-U and WLAN technologies leveraging its Wi-Fi modem to facilitate quick discovery and association with an LTE-U base-station or for other beneficial uses or for other beneficial uses. For example, a WLAN device receiving the information about the LTE-U communication may determine the location of the device transmitting the LTE-U communication (e.g., BS 104) and may null interference from that device in order to enhance reception of WLAN communications at the WLAN device.

In some embodiments, wireless communication system 100 may include additional base stations and LTE-U devices. In some aspects, these devices may access the communication medium (i.e., frequency and time) at the same or substantially the same time as BS 104. Moreover, the additional LTE-U devices may also transmit WLAN communications similar to WLAN communications 504a transmitted by BS 104. In such circumstances, signal collisions may occur. In order to prevent such collisions, in some embodiments, the additional LTE-U devices can transmit copies of WLAN communications 504a. Such copies of WLAN communications 504a can be identical across all transmitting devices in the network. In some embodiments, the additional LTE-U devices transmitting copies of WLAN communications 504a can encode an identical set of MAC layer parameters such as, for example, the same transmission time, address fields, etc., and an identical set of physical layer parameters such as, for example, the same modulation and coding scheme, scrambler seed settings, etc. Because all copies of WLAN communications 504a are identical in an embodiment, receiving devices can demodulate WLAN communications 504a.

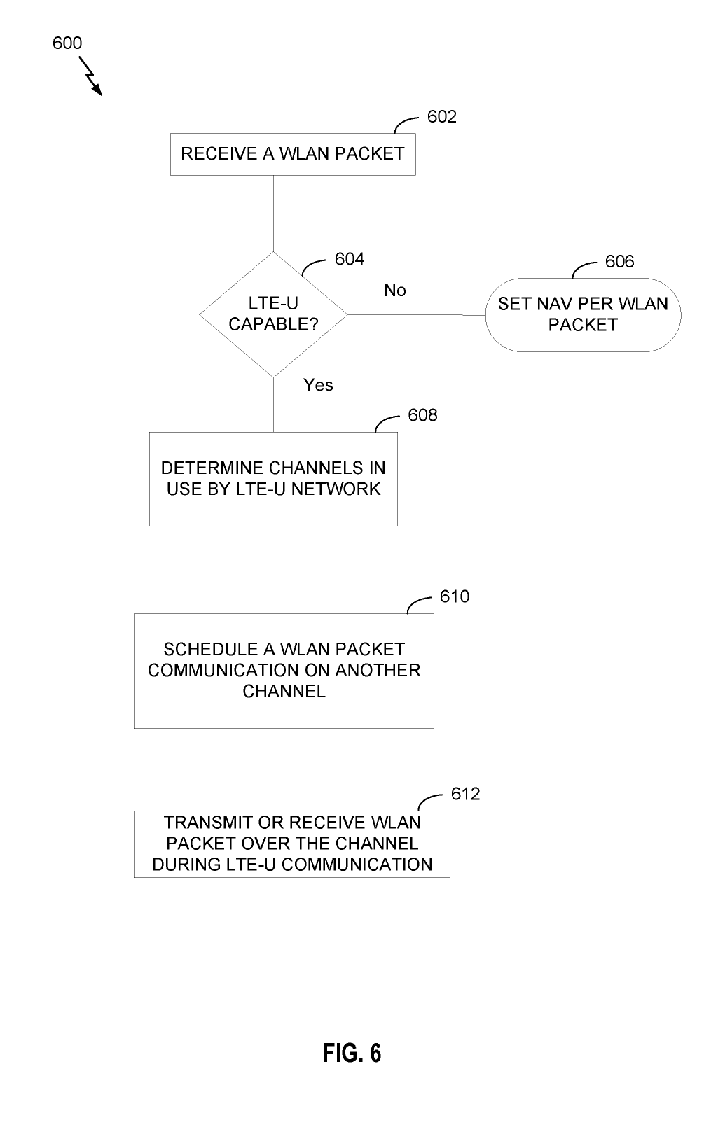

In various embodiments, reception and decoding of the various communications shown in time sequence diagrams 300 and 500 of FIGS. 3 and 5, respectively, can be accomplished in accordance with the methods shown and described below with respect to FIG. 6.

FIG. 6 is a flowchart of an example method 600 for communication. The method is described as implemented by the STA 106. However, as would be understood by one of ordinary skill in the art, the method may be implemented by one or more other suitable electronic devices, such as wireless device 202, or APs 108 or 125. Although blocks may be described as occurring in a certain order, the blocks can be reordered, blocks can be omitted, and/or additional blocks can be added.

At operation block 602, the STA 106 may receive a wireless local area network (WLAN) packet that reserves a communication medium over a time period, the WLAN communication including information about a LTE-U communication. At operation block 604, if the STA 106 is equipped or enabled with hardware or software that allows STA 106 to decode and/or detect LTE-U communications or information about said LTE-U communications, the method may proceed to operation block 608. In some embodiments, the STA 106 may set its NAV even though it is LTE-U capable. If the STA 106 is not equipped with such hardware or software, then method may proceed to operation block 606 and the STA 106 may set its NAV according to the duration of the WLAN communication. At operation block 608 the STA 106 may decode the information about the LTE-U communication and determine the one or more channels used by the LTE-U network. At operation block 610, the STA 106 may then schedule an operation on another channel different from the channels used by the LTE-U network. In some embodiments, the STA 106 may schedule a WLAN transmission to another WLAN device or may schedule a reception of a WLAN transmission from another WLAN device on a different channel during the same time as the LTE-U communication. In some embodiments, the STA 106 may request an AP to switch channels to a new operating channel. In some embodiments, the STA 106 may indicate to the AP that it is going to a power-save state for the duration of the LTE-U communications. In some embodiments the STA 106 may perform an off-channel communication such as a peer to peer (P2P) communication or a Miracast communication or a TDLS communications during the LTE-U on time. At operation block 612, the STA 106 may transmit or receive a WLAN communication during transmission of the LTE-U communication to another WLAN device over a channel different from the one or more channels used by the LTE-U communication.

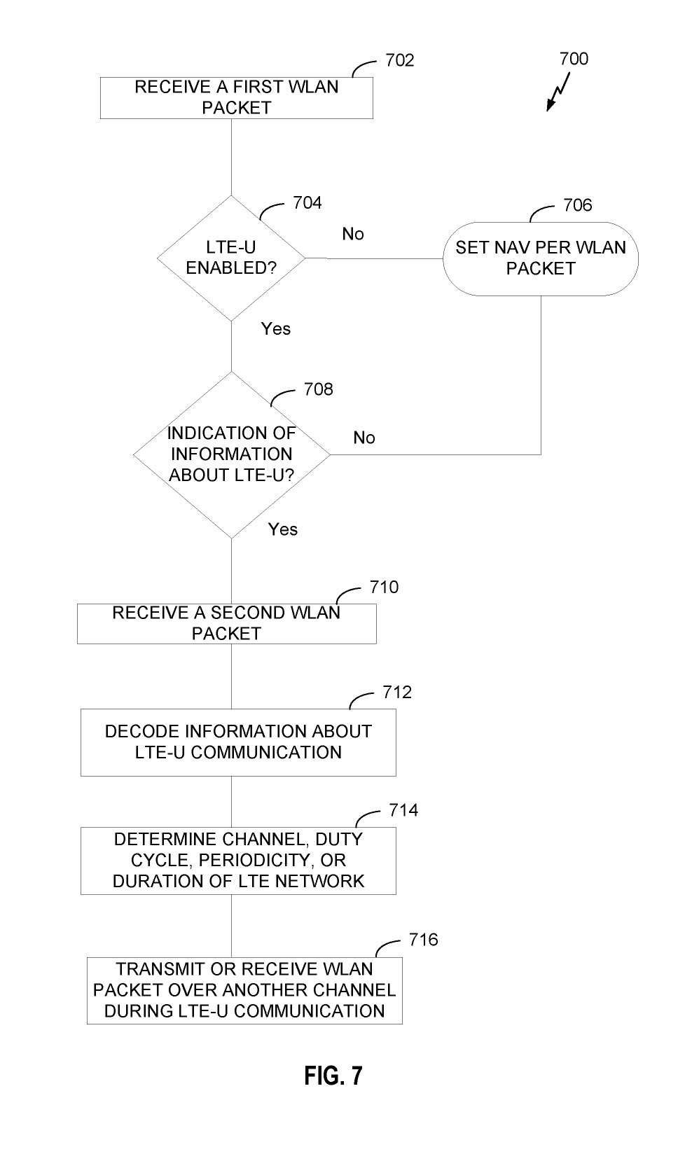

FIG. 7 is a flowchart of an example method 700 for communication. The method is described as implemented by the STA 106. However, as would be understood by one of ordinary skill in the art, the method may be implemented by one or more other suitable electronic devices, such as wireless device 202, or APs 108 or 125. Although blocks may be described as occurring in a certain order, the blocks can be reordered, blocks can be omitted, and/or additional blocks can be added.

At operation block 702, the STA 106 may receive a first wireless local area network (WLAN) packet that reserves a communication medium over a time period. At operation block 704, if the STA 106 is equipped or enabled with hardware or software that allows STA 106 to decode and/or detect LTE-U communications or information about said LTE-U communications, the method may proceed to operation block 708. In some embodiments, the STA 106 may set its NAV even though it is LTE-U capable. If the STA 106 is not equipped with such hardware or software, then method may proceed to operation block 706 and in operation block 706, the STA 106 may set its NAV according to the duration of the first WLAN communication.

At operation block 708, the STA 106 may determine whether the first WLAN communication contains an indication that the first WLAN communication or a second WLAN communication contains information about a LTE-U communication. If not, method proceeds to operation block 706 and the STA 106 set its NAV according to the duration of the first WLAN communication. Upon setting the NAV in block 706, the STA 106 may return to block 702. If the first WLAN communication does contain the indication, then the method proceeds to operation block 710 and the STA 106 receives a second WLAN communication. In some embodiments, the STA 106 may set its NAV even if the STA 106 is LTE-U capable and the first WLAN communication contains an indication that the first WLAN communication or a second WLAN communication contains information about a LTE-U communication. The second WLAN communication may include information about the LTE-U communication. In some embodiments, the STA 106 may set its NAV per the second WLAN communication even if even if the STA 106 is LTE-U capable and the first WLAN communication contains an indication that the first WLAN communication or a second WLAN communication contains information about a LTE-U communication. At operation block 712, the STA 106 may decode the information about the LTE-U communication. The STA 106 may decode this information from either the first WLAN communication or the second WLAN communication or both. At operation block 714, the STA 106 may use the decoded information about the LTE-U communication to determine a channel, a duty cycle, a periodicity, or a duration of the LTE-U communication and/or LTE-U network. This information about the LTE-U communication and/or LTE-U network to schedule WLAN communications that are at least partially concurrent with LTE-U communications or that are scheduled during times when the LTE-U network is not accessing the communications medium. At operation block 716, the STA 106 may transmit or receive a WLAN communication over a different channel than those being used by the LTE-U network. The transmission or reception of the WLAN communication may be at least partially concurrent with an LTE-U communication. In some embodiments, the STA 106 may null interference from the BS 104 in order to better receive WLAN communications during transmission of the LTE-U communication (e.g., LTE-U communication 410a, 510a). In some embodiments, the STA 106 having received information about the LTE-U network as described herein, may request the AP (e.g., AP 108 or AP 125) to migrate the BSS to another channel. In other embodiments, the STA 106 having received information about the LTE-U network as described herein, may go to power-save mode for the duration determined in block 714 of the flow-chart. In some embodiments, the STA 106 having received information about the LTE-U network described herein may schedule local off-channel operation—such as—a P2P communication, a TDLS communication, an off-channel scan, a Miracast communication or some other communications during the LTE-U on time.

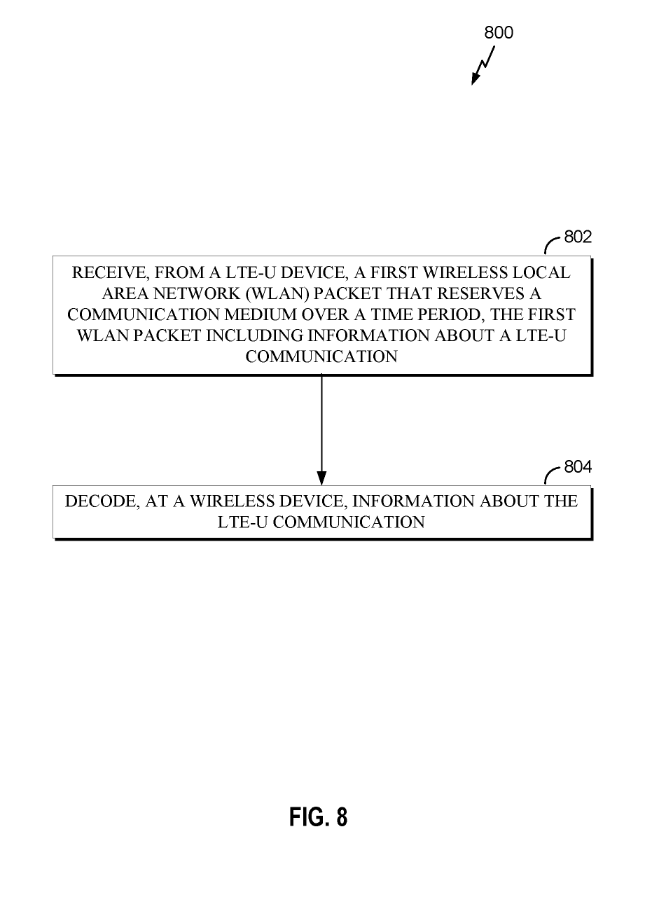

FIG. 8 is a flowchart of an example method 800 for wireless communication. The method is described as implemented by the STA 106. However, as would be understood by one of ordinary skill in the art, the method may be implemented by one or more other suitable electronic devices, such as wireless device 202, or APs 108 or 125. Although blocks may be described as occurring in a certain order, the blocks can be reordered, blocks can be omitted, and/or additional blocks can be added.

At operation block 802, the STA 106 may receive, from a LTE-U device, a first wireless local area network (WLAN) packet that reserves a communication medium over a time period, the first WLAN communication including information about a LTE-U communication. In some embodiments, the STA 106 may selectively set its network allocation vector (NAV) based on the first WLAN communication. In some embodiments, selectively setting the NAV may be further based on whether the STA 106 is equipped with hardware or software for detecting and/or decoding LTE-U communications and/or the LTE-U network.

At operation block 804, the STA 106 can decode the information about the LTE-U communications. For example, the STA 106 can detect, decode, and process the information about the LTE-U communications. As discussed above, the STA 106 can use this additional information to better schedule its own communications around the LTE-U network communications, to aid in network discovery or network timing, to determine the periodicity or duty cycle of LTE-U communications to aid in carrier sense adaptive transmission (CSAT) timing, or to facilitate fast LTE-U network discovery and association using the WLAN modem—e.g.: such as a phone implementing both LTE-U and WLAN technologies leveraging its Wi-Fi modem to facilitate quick discovery and association with an LTE-U base-station or for other beneficial uses or for other beneficial uses.

In some embodiments, an apparatus for wireless communication may perform one or more of the blocks of methods 600, 700, and 800. The apparatus may comprise means for receiving a first wireless local area network (WLAN) packet that reserves a communication medium over a time period, the WLAN communication including information about a LTE-U communication. In some implementations, the means for receiving can be configured to perform one or more of the functions described above with respect to blocks 602, 702, and 802 of FIGS. 6-8. The means for receiving the first WLAN communication may comprise at least processor 204, receiver 212, transceiver 214, or antenna 216 shown in FIG. 2, for example. The apparatus may further comprise means for decoding the information about the LTE-U communication. The means for decoding the LTE-U communication may comprise at least processor 204 shown in FIG. 2 or the LTE modem 304 shown in FIG. 3, for example.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more blocks or actions for achieving the described method. The method blocks and/or actions may be interchanged with one another without departing from the scope of the claims. In other words, unless a specific order of blocks or actions is specified, the order and/or use of specific blocks and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method of decoding additional information about long-term evolution unlicensed (LTE-U) communications for enhancing wireless communication performance, comprising:
receiving, from a LTE-U device, a first wireless local area network (WLAN) packet reserving a communication medium over a time period, the first WLAN communication including information about a LTE-U communication; and
decoding, at a wireless device, information about the LTE-U communication.

2. The method of claim 1, further comprising receiving, from the LTE-U device, a second WLAN communication prior to transmission of the first WLAN communication, the second WLAN communication reserving the communication medium over the time period.

3. The method of claim 2, wherein reception of the second WLAN communication occurs no later than a short interframe space (SIFS) time after a previous communication on the communication medium.

4. The method of claim 2, wherein at least one of the first WLAN communication and the second WLAN communication comprise a clear-to-send to self (C2S) packet.

5. The method of claim 1, wherein the first WLAN communication comprises an indication of a presence of the information about the LTE-U communication in the first WLAN communication, the method further comprises decoding the information about the LTE-U communication.

6. The method of claim 2, wherein the second WLAN communication comprises an indication of a presence of the information about the LTE-U communication in the first WLAN communication, the method further comprises decoding the information about the LTE-U communication.

7. The method of claim 2, wherein the second WLAN communication comprises an indication of a presence of the first WLAN communication, the method further comprises decoding the information about the LTE-U communication.

8. The method of claim 1, further comprising determining a presence of the information about the LTE-U communication based on a value in an information element of the first WLAN communication, the method further comprises decoding the information about the LTE-U communication.

9. The method of claim 2, further comprising determining a presence of the information about the LTE-U communication based on a value in an information element of the second WLAN communication, the method further comprises decoding the information about the LTE-U communication.

10. The method of claim 1, further comprising:
determining one or more of a channel, duty-cycle, duration, and a periodicity of a LTE-U network; and
determining one or more of a channel, duty-cycle, duration, and a periodicity of a WLAN network.

11. The method of claim 10, further comprising:
nulling interference from the LTE-U device; and
receiving another WLAN communication from another device during the time period.

12. The method of claim 1, further comprising determining a channel-estimate from the LTE-U device based on the information about the LTE-U communication included in the first WLAN communication.

13. The method of claim 1, wherein the information about the LTE-U communication comprises a value in one or more training signals located in the first WLAN communication.

14. The method of claim 1, further comprising:
determining a utilization of the communication medium by the LTE-U device based on the information about the LTE-U communication in the first WLAN communication; and
communicating with other devices based on the utilization.

15. The method of claim 1, further comprising:
determining a time period for a communication from the LTE-U device based on the information in the first WLAN communication;
determining a channel for the communication based on the information in the first WLAN communication; and
scheduling a transmission or reception of another WLAN communication on a different channel during the time period.

16. The method of claim 1, wherein the information comprises one or more of: an identifier of a LTE-U network or LTE-U network operator; a position of the first WLAN communication with respect to the LTE-U communication; an identifier of one or more channels occupied by the LTE-U network; a periodicity and/or duty-cycle/duration of the LTE-U communication.

17. An apparatus for wireless communication, comprising:
a receiver configured to receive from a LTE-U device, a first wireless local area network (WLAN) packet reserving a communication medium over a time period, the first WLAN communication including information about a LTE-U communication; and
a processor configured to decode information about the LTE-U communication.

18. The apparatus of claim 17, wherein the receiver is further configured to receive a second WLAN communication prior to transmission of the first WLAN communication, the second WLAN communication reserving the communication medium over the time period.

19. The apparatus of claim 18, wherein the receiver is further configured to receive the second WLAN communication no later than a short interframe space (SIFS) time after a previous communication on the communication medium.

20. The apparatus of claim 18, wherein at least one of the first WLAN communication and the second WLAN communication comprise a clear-to-send to self (C2S) packet.

21. The apparatus of claim 17, wherein the first WLAN communication comprises an indication of a presence of the information about the LTE-U communication in the first WLAN communication, the method further comprises decoding the information about the LTE-U communication.

22. The apparatus of claim 18, wherein the second WLAN communication comprises an indication of a presence of the information about the LTE-U communication in the first WLAN communication, the method further comprises decoding the information about the LTE-U communication.

23. The apparatus of claim 18, wherein the second WLAN communication comprises an indication of a presence of the first WLAN communication, the method further comprises decoding the information about the LTE-U communication.

24. The apparatus of claim 17, wherein the processor is further configured to:
determine a presence of the information about the LTE-U communication based on a value in an ethertype field of the first WLAN communication; and
decode the information about the LTE-U communication.

25. The apparatus of claim 18, wherein the processor is further configured to:
determine a presence of the information about the LTE-U communication based on a value in an ethertype field of the second WLAN communication; and
decode the information about the LTE-U communication.

26. The apparatus of claim 17, wherein the processor is further configured to:
determine one or more of a channel, duty-cycle, duration, and a periodicity of a LTE-U network based on the information about the LTE-U communication in the first WLAN communication; and
determine one or more of a channel, duty-cycle, duration, and a periodicity of a WLAN network based on the first WLAN communication.

27. The apparatus of claim 26, wherein the receiver is further configured to:
null interference from the LTE-U device; and
receive another WLAN communication from another device during the time period.

28. The apparatus of claim 17, wherein the processor is further configured to determine a channel-estimate from the LTE-U device based on the information about the LTE-U communication included in the first WLAN communication.

29. An apparatus for wireless communication, comprising:
means for receiving a first wireless local area network (WLAN) packet that reserves a communication medium over a time period, the first WLAN communication including information about a LTE-U communication; and
means for decoding information about the LTE-U communication.

30. A non-transitory computer readable medium comprising instructions that when executed cause a processor to perform a method of:
receiving, from a LTE-U device, a first wireless local area network (WLAN) packet reserving a communication medium over a time period, the first WLAN communication including information about a LTE-U communication; and
decoding information about the LTE-U communication.
